(19) United States
(12) Patent Application Publication
(10) Pub. No.: US 2007/0007746 A1
(43) Pub. Date: Jan. 11, 2007

(54) Trailer mounted stabilizer

(76) Inventor: Theron Wilson Smith JR., Castle Rock, WA (US)

Correspondence Address: Theron W. Smith Jr., 175 Cutters Spur rd., Castle Rock, WA, 98611, US

(21) Appl. No.: 11/391,641

(22) Filed: Mar. 29, 2006

Related U.S. Application Data
(60) Provisional application No. 60/689,679, filed on Jun. 13, 2005.

(51) Int. Cl. B60P 3/10

(52) U.S. Cl. 280/414.1

(57) ABSTRACT

The invention relates to the loading and unloading of a boat to and from its trailer and the need to keep the boat stabilized in the exact proper position over the trailer while the boat and trailer are removed from the water.

### BACKGROUND OF INVENTION

1. Field

The invention relates to the loading and unloading of a boat to and from its trailer and the need to keep the boat stabilized in the exact proper position over the trailer while the boat and trailer are removed from the water during the loading and unloading process.

2. State of the Art

It is the object of this invention to make the loading and unloading of a boat to and from its trailer as physically simple and mechanically basic as possible

A typical boat when being launched will be immediately subject to wind, wave and currant the instant the boat becomes buoyant.

There has in the past been many patented attempts to salve this dilemma for instants U.S. Pat. No. 5,013,206 in which an entire second frame of the trailer is designed to float while launching. This design is extremely complex and expensive. U.S. Pat. No. 5,228,713 again a second floating frame. U.S. Pat. No. 5,332,249 again the same highly mechanically complex device. Other comparable patents are U.S. Pat. Nos. 3,547,285/3,623,138/3,656,639/3,263,138/ 3,826,319/4,464,092/4,114,920/4,697,812/4,623,161/4,211,513/4,114,772/4,133,577/ 4,268,212/3,856,168/3,826,319/4,365,923/4,013,120/4,112,650 and patent application number 20,030,137,124, and U.S. Pat. No. 3,608,754 which appears to be an entire trailer with a similar hinge point. The patent request in question will mount to most conventional stock boat trailers and adjust to the various widths and lengths of said boats therefore being both simpler by design and more cost effective to the consumer and actually salving the question of how to cost effectively and mechanically simply suspend a floating boat in the exact proper position over the trailer while being put into or removed from the water.

With the for mentioned dilemma in mind this invention was created. The trailer mounted stabilizer consists of two hinging devices one mounted on either side of the boat trailer in front of the for most axle. From each of these hinges a tube projects outward from the trailer frame and these tubes are designed for lateral adjustment to accommodate various widths of boats. At the outer ends of the lateral adjustment tubes an adjustable mounting bracket is permanently fixed at a right angle. Into this bracket the stabilizer arm is secured this arm consisting of a tube having two ends is secured at end one and is structured so that when in place in the lateral adjustment tube it will rise upward and rearward at approximately a forty five degree angle until it reaches the water line of the boat when it is on the trailer out of the water It will then run rearward to approximately two feet from the back of the boat this being end two of the stabilizer tube. It is at this end that a brightly colored device of considerable buoyancy is secured.

The end result being that end number two of the stabilizer tube remains at the water line of the boat at all times during the loading and unloading process and end number one remains secured to the lateral adjustment tube which is pivotally secured to the trailer frame. There by containing the boat directly over the trailer even when suspended in water regardless of wind, wave and currant.

### BRIEF DESCRIPTION OF DRAWINGS

FIG. 1 Is the stationary mounting hole in the hinge body.

FIG. 2 Is the adjustable mounting hole for the hinge body to accommodate various widths of trailer frames.

FIG. 3 Is the trailer flame on which the stabilizer is mounted.

FIG. 4 Are the U bolts used to attach the hinge body to the flame.

FIG. 5 Is an adjustable spacer shim that assures an exact and secure fit of the hinge body to the frame.

FIG. 6 Are the jam nuts that hold the spacer shim (FIG. 5) in place.

FIG. 7 Are the nuts for the U bolts that secure the stabilizer to the frame.

FIG. 8 Is the hinge body.

FIG. 9 Are the bushing that limit wear between the hinge body (FIG. 8) and the lateral adjustment tube (FIG. 10).

FIG. 10 Is the lateral adjustment tube that holds the stabilizer arm and adjusts it to fit various widths of boats.

FIG. 10-A Is the set screws at the end of the lateral adjustment tube that secure the stabilizer arm in place

FIG. 11 Is the clamp that holds both the width and the rotation adjustment of the lateral adjustment tube (FIG. 10).

FIG. 12 Are carriage bolts that secure clamp (FIG. 11) to lateral adjustment tube (FIG. 10).

FIG. 13 Are the nuts that secure the carriage bolts (FIG. 12).

FIG. 14 Is the stabilizer arm.

FIG. 15 Is the adapter cone. This cone having two ends and a center. End one being flared to receive the float (FIG. 19) and end two being structured as to fit inside the stabilizer arm (FIG. 14) and the center sized dawn as to fit the float mounting tube (FIG. 16).

FIG. 16 Is a float mounting tube used to secure the float (FIG. 19) to the adapter cone (FIG. 15). This tube having two ends. End one is flared as not to pass though the mounting hole in the center of the float (FIG. 19) and end two is threaded and used to secure the float (FIG. 19) after passing though the mounting hole in the center of the float.

FIG. 17 Is the nut used to secure the float mounting tube (FIG. 16).

FIG. 18 Is a set screw used to secure adapter cone (FIG. 15) to the stabilizer arm (FIG. 14).

FIG. 19 Is the float with mounting hole though the center.

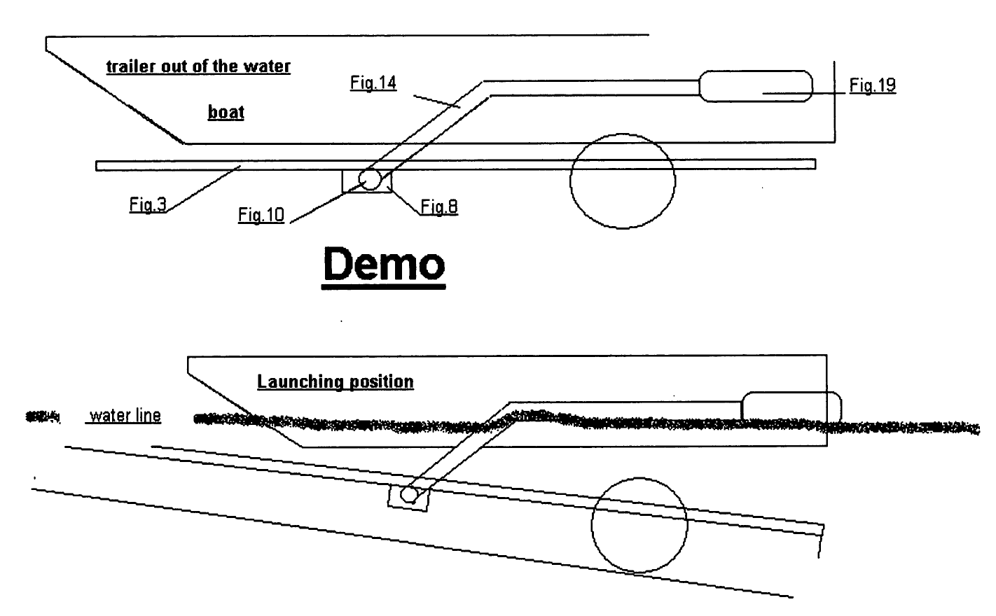

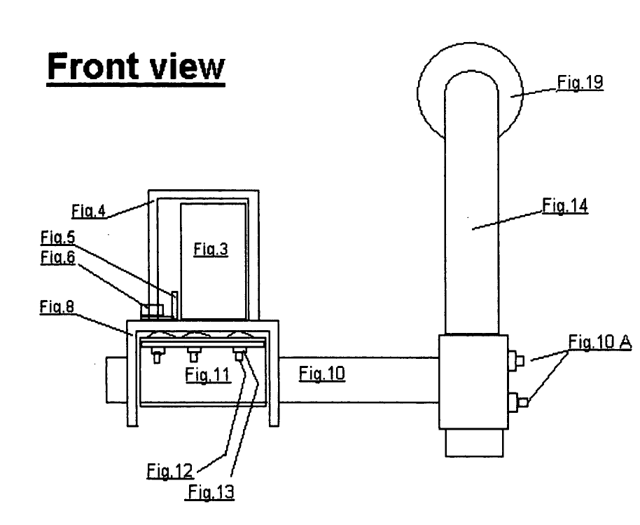

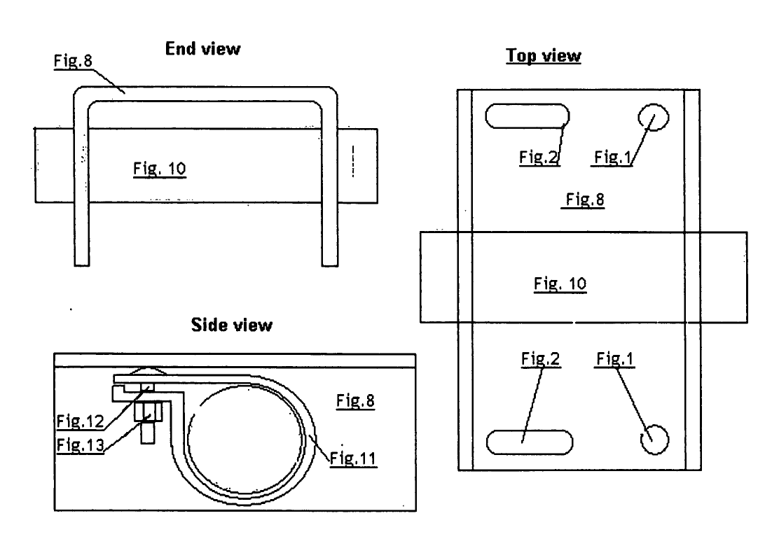

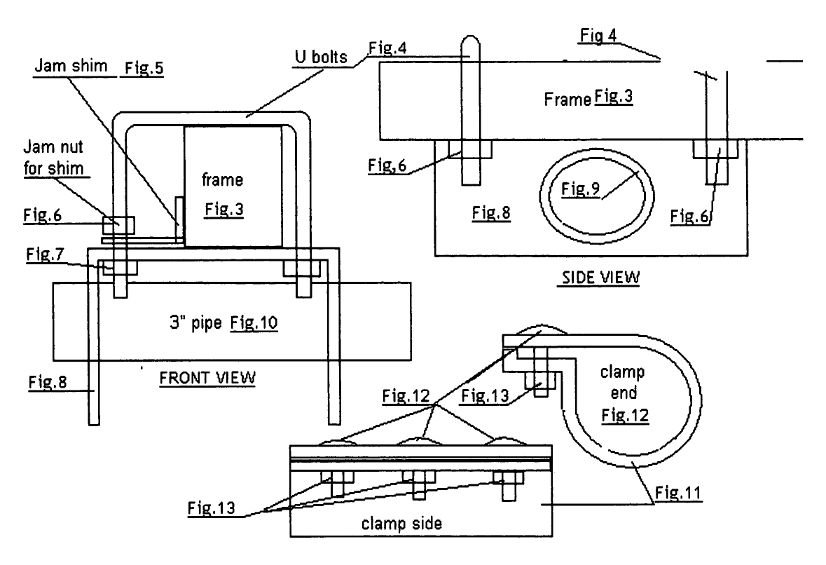

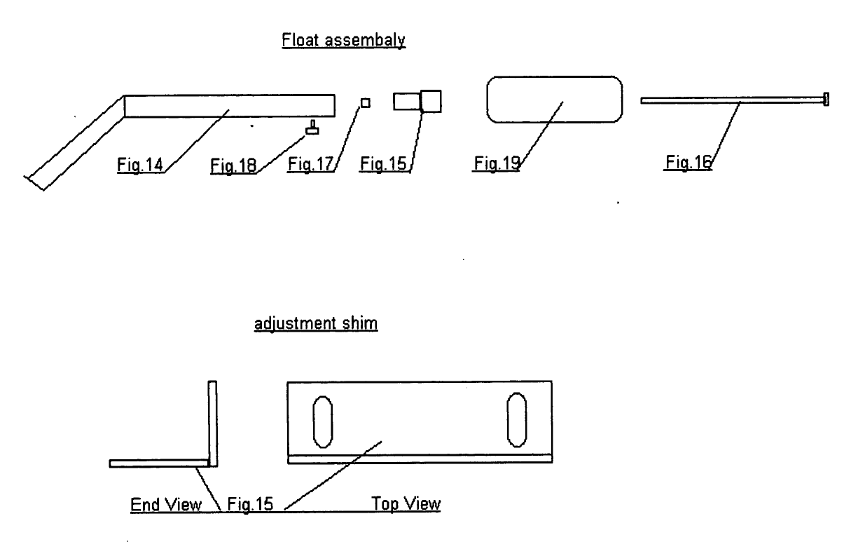

What is claimed is:

1. A trailer having two ends a bow end and a stern end the bow end being the forward end to be attached to a tow vehicle and designed for the transportation of a boat over land and the launching and retrieval of said boat to and from a body of water. Said trailer being comprised of two elongated parallel frame rails horizontal to the ground and to the underside of said frame rails an axle is secured having wheels secured at either end.

2. To the trailer of claim 1, one on each of the two parallel frame rails forward of said axle and to the under side of said frame rail is mounted a hinge body. Said hinge body is comprised of an elongated chanal type housing which is mounted parallel with the trailer frame by means of mounting holes in the top and the open side of said chanal being the bottom facing down. In either side of said chanal is a hole of sufficient size as to support the bushing of claim 7, bushing and the a lateral adjustment tube of claim 5.

3. To the trailer of claim 1, is mounted the hinge body of claim 2, by means of two U bolts one forward of the other.

4. A spacer having two slotted mounting holes and structured at a right angle and long enough to span between the forward and rear U bolts of claim 3, is mounted on top of the hinge body of claim 2, and fitted snugly to the inner side of the frame rail of claim 1, and secured by means of jam nuts on the U bolts of claim 3, thereby fitting the hinge body of claim 2, to the various sizes of frames of claim 1, perfectly.

5. A lateral adjustment tube having two ends being comprised of a tube large enough to support the stabilizer arm of claim 8, end one being plain and end two having a clamp (consisting of a tube large enough for the stabilizer arm of claim 8, to fit inside and having not less than two set screws to secure said stabilizer arm of claim 8, in place) permanently secured at a right angle

6. A clamping device comprised of a circular band with a inside diameter slightly larger than the outside diameter of the lateral adjustment tube of claim 5, and a width slightly narrower than the inside width of the hinge body of claim 2, and a tension relief slot running end to end. Both above and below said slot a flat plate with three holes each and as long as the band is wide are permanently fixed parallel each other. Three bolts are put though the holes and when said bolts are tightened the tension relief slot will close there by reducing the inside diameter.
The clamp of claim 6, is then put inside the chanal and lined up with the lateral adjustment holes in the sides of the hinge body of claim 2, The Bushings of claim 7, are put into the lateral adjustment holes in the sides of the hinge body of claim 2, and the lateral adjustment tube of claim 5, is then put though the first bushing of claim 7, then though the clamp of claim 6, and then though the second bushing of claim 7, the lateral adjustment tube of claim 5, is pushed though the hinge body of claim 2, to the desired adjustment and then rotated to the desired adjustment and then the bolts in the clamp of claim 5, are tightened.
The end result being that the lateral adjustment tube of claim 5, is now secured from moving side to side because the clamp of claim 6, is inside the chanal of the hinge body of claim 2, and the bolts in the clamp of claim 6, will contact the under side of the top of the chanal of the hinge body of claim 2, thereby allowing the lateral adjustment tube to rotate only so far before stopping.

7. A ware bushing with a inside diameter slightly larger than the outside diameter of the lateral adjustment tube of claim 5, and an outside diameter to match the lateral adjustment holes in the sides of the hinge body of claim 2.

8. A stabilizing arm consisting of a tube having two ends and structured as to when end one is in place in the lateral adjustment tube of claim 5, the tube rises upward and rearward to the water line of a boat when in place on the trailer of claim 1, it then runs parallel the water line of said boat toward the rear of the boat stopping far enough from the rear of said boat as to allow for the mounting of the floatation device of claim 9, this being end two.

9. A floatation device consisting of an elongated buoyant device structured as to have a mounting hole though the center running end to end and sufficient buoyancy to float end two of the stabilizer arm of claim 8.

10. A mounting flange having two ends, end one sized as to fit tightly inside end two of stabilizer arm of claim 8, and end two to be flared as to allow the float of claim 9, to be held firmly in place without causing damage to said float.

11. A tube having two ends and being long enough to pass all the way though the float of claim 9, and the mounting flange of claim 10, end one being threaded and end two being flared as not to allow the tube to pass through the float of claim 9,

12. A nut to fit end one of the tube of claim 1.

13. A self tapping screw used to secure the flange of claim 10, to end two of the stabilizer arm of claim 8.
